(19) United States
(12) Patent Application Publication
(10) Pub. No.: US 2010/0269857 A1
(43) Pub. Date: Oct. 28, 2010

(54) METHOD FOR OPERATING AN ATTACHMENT DEVICE FOR A VACUUM CLEANER AND A CORRESPONDING ATTACHMENT DEVICE

(75) Inventors: Walter ASSMANN, Bielefeld (DE); Martin BEHRENSWERTH, Hilter (DE); Guenther ENNEN, Enger (DE); Volker MARKS, Bielefeld (DE); Cornelius WOLF, Bielefeld (DE)

Correspondence Address: Leydig, Voit & Mayer, Ltd. (Frankfurt office), Two Prudential Plaza, Suite 4900, 180 North Stetson Avenue, Chicago, IL, 60601-6731, US

(73) Assignee: MIELE & CIE. KG, Guetersloh (DE)

(21) Appl. No.: 12/765,162

(22) Filed: Apr. 22, 2010

(30) Foreign Application Priority Data
Apr. 23, 2009 (DE) 10 2009 018 338.8

(51) Int. Cl. B08B 1/04; A47L 9/04; A47L 11/40; A47L 9/28

(52) U.S. Cl. 134/6; 15/377; 15/389

(57) ABSTRACT

A method for operating an attachment device for a vacuum cleaner includes an electrically rotatable brush roller and a motor for driving the brush roller. The method includes rotating the brush roller in a normal operational direction during operation. The method further includes rotating the brush roller in a reverse direction opposite to the normal operational direction of rotation, when the brush roller is detected to be jammed.

### CROSS-REFERENCE TO RELATED APPLICATIONS

This application claims the benefit of German Patent Application No. 10 2009 018 338.8 filed on Apr. 23, 2009.

### FIELD

The disclosure relates to a method for operating an attachment device for a vacuum cleaner. The disclosure also relates to an attachment device that is particularly suitable for carrying out the method.

### BACKGROUND

Methods for operating attachment devices for vacuum cleaners are generally known. The attachment devices concerned have an electrically rotatable brush roller and a motor for driving the same, and are used, for example, to clean carpeted floors. During operation, the brush roller usually rotates in one direction, but there are known methods where a direction of rotation of this brush roller is reversed during operation, and generally in such a way that the brush roller always rotates in a direction of movement of the attachment device, thus facilitating movement of the attachment device. A method of this kind is described, for example, in DE 689 05 252 T2 and EP 1 352 603 A1.

However, when vacuuming with attachment devices that include a rotatable brush roller, such brush roller may happen to get jammed, for example, in response to garments, rugs, or rug fringes accidentally getting caught and wound up by the brush roller. In such a case, usually, the motor of the brush roller turns off, and the object that was caught must be removed manually, for example, by pulling on it. To do this, it is necessary to overcome the resistance of the brush roller motor while the motor is off.

### SUMMARY

In an embodiment, the present disclosure provides a method for operating an attachment device for a vacuum cleaner in which the attachment device includes an electrically rotatable brush roller and a motor for driving the same. The method includes rotating the brush roller in a normal operational direction of rotation during operation and rotating the brush roller in a reverse direction of rotation opposite to the normal operational direction when the brush roller is detected to be jammed.

### BRIEF DESCRIPTION OF THE DRAWINGS

FIG. 1 is a simplified schematic view of a vacuum cleaner with an attachment device having a brush roller; and

FIG. 2 is a block diagram of an exemplary embodiment of an attachment device adapted for connection to a vacuum cleaner and designed according to the disclosure.

### DETAILED DESCRIPTION

The disclosure provides a method which allows objects that are wound up on the brush roller to be removed more easily, and to provide an attachment device for carrying out this method.

To this end, in a method for operating an attachment device for a vacuum cleaner, the attachment device including an electrically rotatable brush roller and a motor for driving the same, and the brush roller being rotated in a normal operational direction of rotation during operation, provision is made for the brush roller to be rotated in a direction opposite to the normal operational direction of rotation—reverse direction of rotation—when the brush roller is detected to be jammed.

The advantage of the disclosure is that it allows objects wound up on the brush roller to be wound off automatically in the manner described herein. Thus, a user does not need to pull on the object, so that the object does not get damaged, for example, by the pulling force that must be exerted to overcome the resistance of the motor. When, for example, rug fringes are caught in the brush roller, the attachment device is generally very close to the surface of the rug, so that there is little space to free the fringes by hand. In this case, too, rotating the brush roller in a reverse direction allows the rug fringes to be released in a simple and rapid manner.

The motor is preferably a brushless permanent magnet motor. This is an advantage, because the commutators required in commutator motors are subject to substantial wear, which may lead to malfunctions. In addition, this allows for sensorless monitoring of the motor, for example, by monitoring the current consumption, which eliminates the need for failure-prone sensors, such as, for example, Hall sensors. When using a brush roller motor which is controlled via three phases, the direction of rotation can be reversed in a simple and generally known manner by interchanging two phases.

Advantageous embodiments are the subject matter of the dependent claims. The antecedents used therein refer, by the features of the respective dependent claim, to a further embodiment of the subject matter of the main claim; they are not to be understood as renouncing attainment of an independent protection of subject matter for the combinations of features of the dependent claims having the main claim as antecedent reference. Furthermore, with regard to an interpretation of the claims in the case of a more detailed concretization of a feature in a subordinate claim it is to be assumed that a restriction of said kind is not present in the respective preceding claims.

Preferably, jamming is detected when the current consumption of the motor exceeds a predetermined or predeterminable threshold value. This takes into account that not all surfaces present identical vacuuming conditions. In particular, depending on the surface to be vacuumed, the current consumption may slightly increase already when vacuuming a carpeted floor having a pile of varying length or thickness. In such a situation, no jamming will be detected when the threshold is set to a higher value in which such surfaces are suitably taken into account. Thus, in the case of surfaces that offer somewhat greater resistance to movement, the use of the attachment device is not impaired by reverse rotation, which is usually unwanted in such circumstances.

Particularly preferably, jamming is detected when the current consumption exceeds the threshold value for a predetermined or predeterminable period of time. In this manner, brief, sharp increases in current consumption, which may be caused by the attachment device “getting stuck” on the surface to be vacuumed, are prevented from being interpreted as jamming and causing the brush roller to be rotated in a reverse direction. This avoids unwanted rotation in reverse, thus preventing the movement of the attachment device from being additionally hindered.

Preferably, the brush roller is rotated in a reverse direction by a predetermined or predeterminable angle—angle of reverse rotation—upon occurrence of jamming. Suitable values for the angle of rotation were found to be in the range from 15 to 360 degrees. Reverse rotation through such an angle may prevent wound-up objects from being wound up again when brush roller is rotated too far in the opposite direction. In the case of a small angle of reverse rotation, such as 15 degrees, the object may possibly not be completely released, but at least be loosened, so that it can then be easily removed by slightly pulling on it. Moreover, it is possible to return to the normal operational direction of rotation more rapidly and resume the cleaning operation.

In an alternative embodiment, the motor of the brush roller is stopped upon occurrence of jamming, and the brush roller is rotated stepwise in the reverse direction by a predetermined or predeterminable angle each time a switch element is actuated. Thus, reverse rotation of the brush roller does not occur automatically, but can be adjusted to the type of object wound up. For example, the switch element may be actuated by a user who decides on how far to reverse the brush roller by actuating the switch element a corresponding number of times. This facilitates removal of longer and/or thinner objects, which may sometimes wind up around the brush roller several times.

Preferably, a rotational speed at which the brush roller is rotated in the reverse direction in the event of jamming is lower than a rotational speed in the normal operational direction of rotation. In this manner, objects being wound off are prevented from being wound up in the opposite direction of rotation.

When the brush roller is returned to operation in the normal operational direction of rotation, for example, by pressing a start button, after jamming has been detected and, as the case may be, after the brush roller has been rotated back, the point in time at which normal operation is resumed can be chosen by the user. This allows the user to first remove the loosened objects, if necessary, or to place the attachment device on a different spot, thereby preventing objects from being immediately wound up again when the brush roller is reactivated. The start button may be disposed, for example, directly on the attachment device. A simpler alternative is to reactivate the brush roller of the attachment device by turning the vacuum cleaner first off and then on again by a main switch instead of using the start button. In this case, the attachment device does not need an additional switch.

Preferably, provision is made for a generator mode of operation to generate a signal to resume operation in the normal operational direction of rotation. Operation of the brush roller motor in generator mode is achieved by pushing the attachment device in a particular direction. In the process, the friction created by the contact of the brush roller with the floor causes the brush roller to rotate. This rotation results in the motor generating a voltage that can be used as a signal to return the brush roller to operation in the normal operational direction of rotation. In this manner, the cleaning operation can be rapidly resumed without further manipulation by the user.

Preferably, during operation, the normal operational direction of rotation of the brush roller is adjusted to match a forward or backward movement of the attachment device, and the reverse direction of rotation is determined according to the particular normal operational direction of rotation. To this end, the respective normal operational direction of rotation may be stored in a control unit of the brush roller motor in order for the brush roller to rotate in the respective opposite direction in the event of jamming.

In an attachment device for a vacuum cleaner, the attachment device having an electrically rotatable brush roller and a motor for driving the same, provision is made for means for detecting jamming of the brush roller and for emitting a jamming signal to reverse the direction of rotation of the motor, said means, as a whole, being referable to as “jamming detection means”.

Furthermore, advantageous embodiments of the attachment device mentioned above and used to achieve the object mentioned earlier using the above-described method and embodiments thereof has, as essential features, means for carrying out individual steps encompassed by the method and embodiments thereof. It this respect, reference is essentially made to the preceding description of the method and embodiments thereof

Preferably, a current sensor for measuring the current consumption of the brush roller motor, and a monitoring device for emitting a jamming signal when the current exceeds a predetermined or predeterminable threshold value, are disposed in the attachment device. This keeps signal paths short during current consumption monitoring and transmission to the monitoring device, which in turn is beneficial for EMC and reduces the cost of wiring, etc.

Particularly preferably, the attachment device has provided therein means for monitoring the presence of the jamming signal for a period of time exceeding a predetermined or predeterminable period of time. These means may be included, for example, in a control unit for controlling the motor. A simple example is a counter which is started by the jamming signal and which indicates the elapse of a period of time when this period of time has expired.

Also preferably, a push button is provided, for example, on the top of the attachment device, as the switch element for rotating the brush roller, in particular stepwise, in the reverse direction by a predetermined or predeterminable angle. Each time a user actuates the push button, the brush roller is rotated back by this angle. The button may be actuated as many times as desired or necessary to loosen wound-up objects.

Preferably, the attachment device is provided with a start button, for example, on a top thereof, allowing the brush roller to be rapidly returned to operation in the normal operational direction of rotation after a jamming event has occurred and, as the case may be, after the brush roller has been rotated back. Alternatively, starting may be accomplished through generator action.

In a preferred embodiment, the attachment device includes means enabling the direction of operation of the brush roller to be reversed during operation, particularly according to a forward or backward movement of the attachment device. In this manner, the movement of such an attachment device over a surface may be facilitated, because the friction with the surface caused during the rotation of the brush roller produces a force that promotes said movement when the brush roller rotates in the corresponding direction of movement. Otherwise, the movement of the attachment device may be hindered in one direction to different degrees, depending on the properties of the surface. An attachment device designed in this manner may further be provided with means for storing a direction in which the brush roller was rotating during normal operation before it jammed, which means may then be used to activate the corresponding reverse direction of rotation that is suitable to release the jam. These means may be disposed, for example, in a control unit of the attachment device.

An exemplary embodiment will be described in more detail below with reference to the drawing. Corresponding objects or elements are identified by the same reference numerals in all figures.

It is understood that neither this or any other exemplary embodiment should be construed as limiting the scope of the claims. Rather, within the framework of the present disclosure, numerous revisions and modifications are possible, in particular such variants and combinations, which, for example, by combining or altering individual features or elements or method steps described in connection with the general or detailed description, as well as the claims, and contained in the drawings, may be inferred by one skilled in the art with regard to achieving the objective, and lead, through combinable features, to a new subject matter or to new method steps or sequences of method steps.

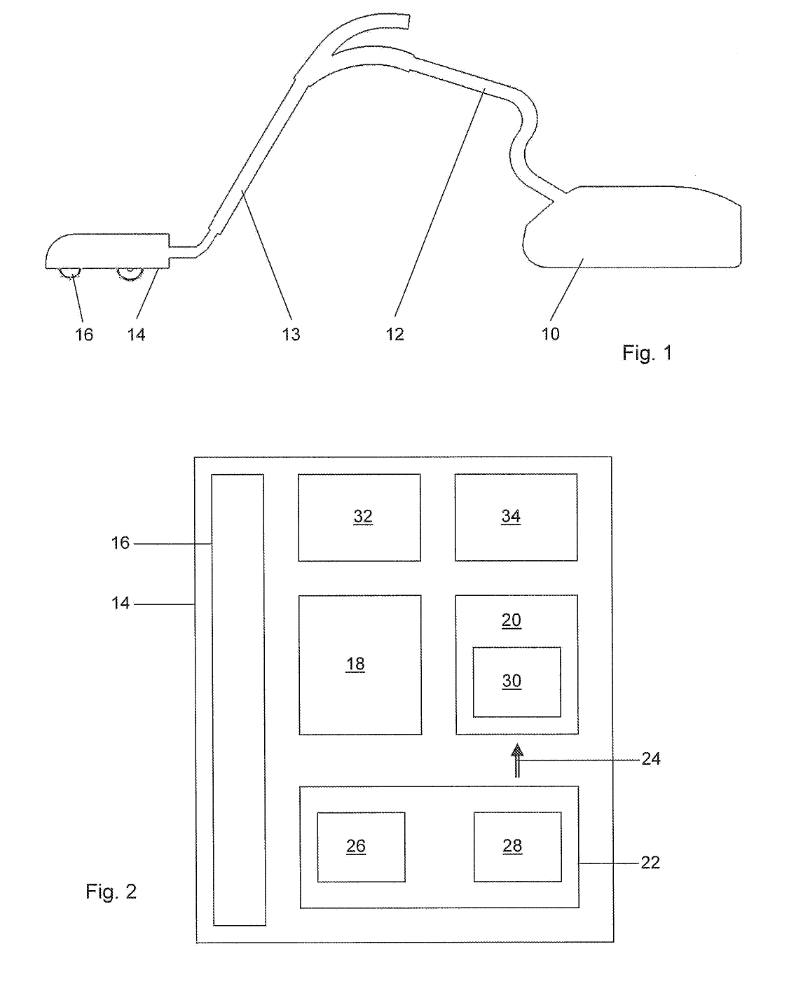

FIG. 1 shows, in a simplified schematic view, a vacuum cleaner 10 which is connected to an attachment device 14 via a suction hose 12 and a suction wand 13. An electrically rotatable brush roller 16 is disposed at the bottom of attachment device 14. Such an attachment device 14 is intended primarily for vacuuming of carpeted floors.

FIG. 2 shows attachment device 14 in a greatly simplified, block diagram form. Brush roller 16 is driven by a motor 18. Motor 18 may be, for example, a brushless motor having a permanent magnet as a rotor, and in this exemplary embodiment is monitored by a control unit 20 in a sensorless manner. When, during operation, objects, such as garments or parts of a carpet, get caught and wound up by brush roller 16 as it rotates in a normal operational direction of rotation, brush roller 16 may get jammed. Suitable means for detecting jamming—jamming detection means 22—detect the jamming event and emit a jamming signal 24, symbolized by an arrow. Jamming detection means 22 include a current sensor 26 and a monitoring device 28. Current sensor 26 monitors the current consumption of motor 18. When the current consumption exceeds a predetermined or predeterminable threshold value, which may depend on the motor parameters, such as coil resistance and the voltage supplied to motor 18, monitoring device 28 emits jamming signal 24, for example, to control unit 20. Control unit 20 includes means 30 for monitoring the period of time during which jamming signal 24 is present. When a predetermined or predeterminable period of time is exceeded, the condition of brush roller 16 is interpreted as a jamming event, and brush roller 16 is rotated in a reverse direction of rotation which is opposite to the normal operational direction of rotation. Reverse rotation may either occur automatically immediately upon detection of jamming, causing brush roller 16 to be rotated back by a predetermined or predeterminable angle in the range of, for example, from 15 to 360 degrees. Alternatively, the reverse rotation may be performed stepwise by a user actuating a switch element, for example, a push button 32, after the rotation of brush roller 16 in the normal operational direction of rotation has been stopped upon detection of jamming. In the process, brush roller 16 may be rotated back in any number of steps of, for example, 15 degrees. Reverse rotation may be performed at a lower speed than the rotation of brush roller 16 during normal operation. After the jam is cleared; i.e., after objects wound up on brush roller 16 have been wound off or freed, brush roller 16 can be returned to normal operation by actuating a start button 34 disposed on attachment device 14, for example, on the top thereof. Of course, normal operation may also be resumed by turning vacuum cleaner 10 (FIG. 1) and/or attachment device 14 first off and then on again using an ON/OFF switch. Optionally, brush roller 16 may also be operated in generator mode, resulting in the emission of a signal to resume the normal operational direction of rotation. Operation of brush roller 16 in generator mode may be achieved, for example by pushing attachment device 14 across the surface to be cleaned, in which process brush roller 16 is rotated due to the friction with the surface.

It may be provided for brush roller 16 of attachment device 14 to rotate during normal operation either in one direction only, or to change its direction of rotation during operation according to a forward or backward movement of attachment device 14. In the last-mentioned embodiment, attachment device 14 or control unit 20 includes suitable means capable of determining the direction in which brush roller 16 was last rotating before it jammed, so that brush roller 16 will then rotate back in the respective opposite direction. When returning brush roller 16 to normal cleaning operation, it may rotate, for example, in any direction. However, if the return to normal operation is initiated through generator action, the direction of movement of attachment device 14 is detected by suitable means, and brush roller 16 is then driven in this direction.

Thus, provided are a method for operating an attachment device 14 for a vacuum cleaner 10, and an attachment device 14 operating in accordance with this method, the attachment device having an electrically rotatable brush roller 16 and a motor 18 for driving the same, and brush roller 16 being rotated in a normal operational direction of rotation during operation, provision being made for brush roller 16 to be rotated in a direction opposite to the normal operational direction of rotation—reverse direction of rotation—when brush roller 16 is detected to be jammed. To this end, attachment device 14 is provided with suitable means—jamming detection means 22—for detecting jamming and emitting a jamming signal 24 to reverse the direction of rotation of motor 18.

1-15. (canceled)

16. A method for operating an attachment device for a vacuum cleaner, the attachment device including an electrically rotatable brush roller and a motor for driving the brush roller, the method comprising:
rotating the brush roller in a normal operational direction of rotation during operation; and
rotating the brush roller in a reverse direction opposite to the normal operational direction of rotation when the brush roller is detected to be jammed.

17. The method as recited in claim 16, further comprising detecting jamming when the current consumption of the motor exceeds a predetermined or predeterminable threshold value.

18. The method as recited in claim 17, wherein the detecting jamming is performed so as to detect jamming when the current consumption exceeds the threshold value for a predetermined or predeterminable period of time.

19. The method as recited in claim 16, wherein the brush roller is rotated in the reverse direction by a predetermined or predeterminable angle upon an occurrence of jamming.

20. The method as recited in claim 16, further comprising stopping the motor of the brush roller upon an occurrence of jamming, and wherein the brush roller is rotated stepwise in the reverse direction by a predetermined or predeterminable angle each time a switch element is actuated.

21. The method as recited in claim 16, wherein a rotational speed at which the brush roller is rotated in the reverse direction in an event of jamming is lower than a rotational speed in the normal operational direction of rotation.

22. The method as recited in claim 16, further comprising returning the brush roller to operation in the normal operational direction of rotation by an actuation of a start button.

23. The method as recited in claim 16, further comprising generating, in a generator mode, a signal so as to resume operation in the normal operational direction of rotation.

24. The method as recited in claim 16, further comprising:
adjusting, during operation, the normal operational direction of rotation of the brush roller so as to match a forward or backward movement of the attachment device, and
determining the reverse direction of rotation according to the adjusted normal operational direction of rotation.

25. An attachment device for a vacuum cleaner, comprising:
an electrically rotatable brush roller;
a motor configured to drive the brush roller; and
a monitoring device configured to detect jamming of the brush roller and emit a jamming signal so as to reverse a direction of rotation of the motor.

26. The attachment device as recited in claim 25, further comprising a current sensor configured to measure a current consumption of the motor, wherein the monitoring device is configured to emit the jamming signal when the current exceeds a predetermined or predeterminable threshold value.

27. The attachment device as recited in claim 26, further comprising a monitoring unit configured to monitor a presence of the jamming signal for a period of time exceeding a predetermined or predeterminable period of time.

28. The attachment device as recited in claim 25, further comprising a push button for rotating the brush roller in the reverse direction by a predetermined or predeterminable angle.

29. The attachment device as recited in claim 28, wherein the rotating of the brush roller in the reverse direction is stepwise.

30. The attachment device as recited in claim 25, further comprising a start button for returning the brush roller to operation in the normal operational direction of rotation.

31. The attachment device as recited in claim 30, wherein the brush roller is configured to reverse its direction of rotation during operation.

32. The attachment device as recited in claim 31, wherein the brush roller is configured to reverse its direction of rotation according to a forward or backward movement of the attachment device.
